(19) United States
(12) Patent Application Publication
(10) Pub. No.: US 2004/0012490 A1
(43) Pub. Date: Jan. 22, 2004

(54) Brake alarm device

(76) Inventor: Liang Wen Chen, Taipei (TW)

Correspondence Address: Liang Wen Chen, Box 8-24, 235 Chung-Ho, Taipei, TW

(21) Appl. No.: 10/195,168

(22) Filed: Jul. 16, 2002

(51) Int. Cl. B60Q 1/44; G08B 5/22

(52) U.S. Cl. 340/479; 340/815.45

(57) ABSTRACT

A brake alarm device integrated circuit is disclosed. When a high voltage is inputted into a first primary input, current flow through the first diode and then a positive bias will cause the second integrated circuit to light up a plurality of first LEDs. When a high voltage is inputted into a second primary input end, the first resistor will conduct the first integrated circuit. When a high voltage is inputted into the third primary input end, current therethrough and then the third resistor will conduct the third integrated circuit; a positive bias of the second integrated circuit will be suppressed to a low level. Thereby, the second integrated circuit will be actuated; then the first LEDs will extinguished; if the high voltage is stopped to input to the third primary input end, the first LEDs will light up. Thereby, different lights are used to represent different brake condition.

### FIELD OF THE INVENTION

The present invention relates to brake alarm devices, and particularly to brake alarm device at the back side of a car. The indication is performed by LEDs so as to enhance the alert effect.

### BACKGROUND OF THE INVENTION

In general, red light is used in the prior art brake alarm device. Relays and display elements are used as the components of the device. Thereby, the volume of the portion is large and the display is not as quick as desired so that the car behind the alerting car not take a response immediately. Therefore, the possibility of a traffic accident will increase.

### SUMMARY OF THE INVENTION

Accordingly, the primary object of the present invention is to provide a brake alarm device which is installed at a back side of a car.

Another object of the present invention is to provide a brake alarm device, wherein yellow LEDs represent that the oil is stopped from supplying to the engine, and red LEDs represent that the brake is actuate and the green light represent that the car is in normal condition.

To achieve above objects, the present invention provides a brake alarm device integrated circuit. When a high voltage is inputted into the first primary input, current flow through the first diode and then the fifth resistor will conduct the second integrated circuit; a positive bias will cause the second integrated circuit to light up the plurality of first LEDs. When a high voltage is inputted into the second primary input end, the first resistor will conduct the first integrated circuit; a positive bias will cause the first integrated circuit to light up the second serial connected LED. When a high voltage is inputted into the third primary input end, current flow through the third diode and then the third resistor will conduct the third integrated circuit. A positive bias of the second integrated circuit will be suppressed to be at low level; thereby, the second integrated circuit will be actuated. Then the first LEDs will extinguished; if the high voltage is stopped to input to the third primary input end, the first LEDs will light up.

The various objects and advantages of the present invention will be more readily understood from the following detailed description when read in conjunction with the appended drawing.

### BRIEF DESCRIPTION OF THE DRAWINGS

FIG. 1 shows the circuit structure of the present invention.

FIG. 2 shows the display board of the-present invention.

FIG. 3 shows one embodiment of the present invention.

### DETAILED DESCRIPTION OF THE PREFERRED EMBODIMENTS

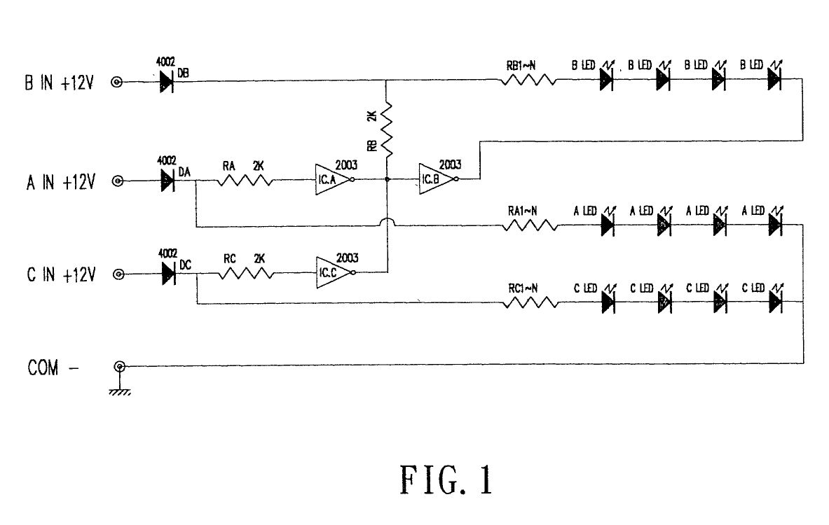

Referring to FIG. 1, the brake alarm device of the present invention is illustrated. The brake alarm device of the present invention comprises integrated circuit IC A, IC B, and IC C, diode DB, DA, DC, a plurality of resistors RA, RB, RC, RB1˜N, RA1˜N, RC1˜N and light emitting diode ALED, BLED, CLED which are connected logically. The input ends A, 13 and C are connected to a brake switch and an illumination switch, as illustrated in FIG. 1.

The operation of the present invention will be described herein.

When a 12 V voltage is inputted into the input end B, current flow through the diode DB and then the resistor RB will conduct the IC B. The positive bias will cause the integrated circuit IC B to operate the LED B. Therefore, yellow light is emitted.

When a 12 V voltage is inputted into the input end A, the resistor RB will conduct the IC A. The positive bias will cause the integrated circuit IC A to emit red light. If the bias of the integrated circuit IC B reduces to a lower level so that the integrated circuit IC B is conducted and thus the LED B will extinguish. If the voltage of 12V is not further inputted to the integrated circuit A, then the integrated circuit B will restore automatically to emit yellow light.

When a 12 V voltage is inputted into the input end C, current flow through the diode DC to actuate the LEDs C and then the resistor RC will conduct the IC C. The positive bias of the integrated circuit IC B will be suppressed to be at low level. Thereby, the integrated circuit IC B will be actuated. Then the LED B will extinguished. If the voltage of 12 V is stopped to input the input end C, the LED B will light up.

In summary

If LEDs A (red) are light up, the LEDs B (yellow) will extinguish automatically.

The LEDs B normally light up and the LDEs A and C (green) normally extinguish.

If LEDs C (green) light up, the LEDs B (yellow) will extinguish automatically.

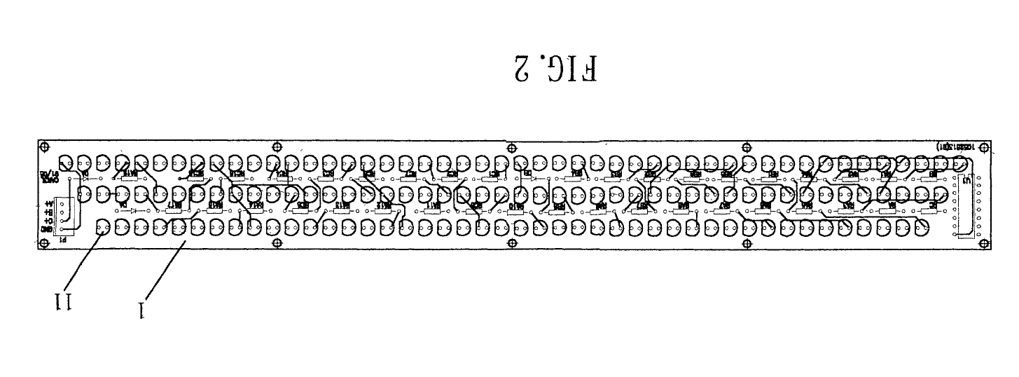

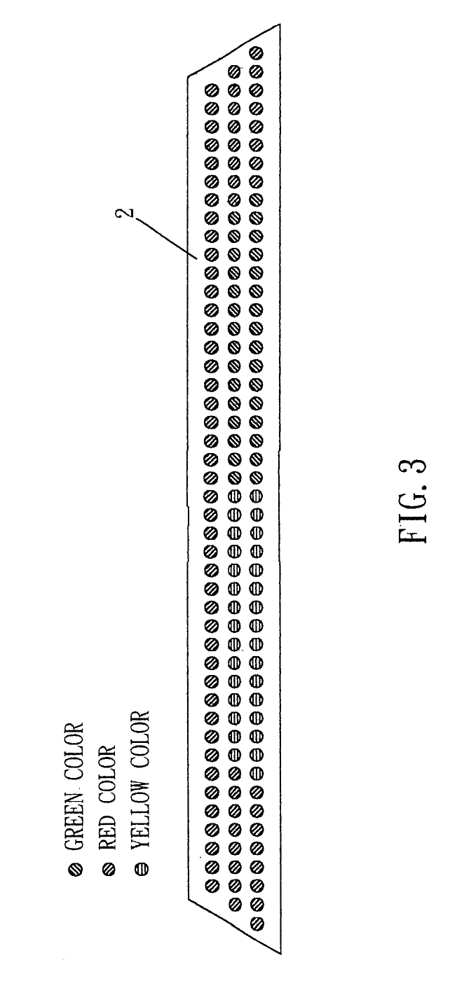

Referring to FIGS. 2 and 3, a plurality of light emitting diode 11 are installed on a circuit board 1. A brake display device is used to emit red, yellow and green light. The red light represent brake control signals, yellow light represents oil valve signals, and green light represent that brake is not actuated”.

The brake alarm device of the present invention has the following features.

(1) The volume is small and collectors of the integrated circuit are opened.

(2) A plurality of light emitting diode (LEDs) lights up for a longer time.

(3) The diode is used to prevent the circuit from damage as the circuit is connected in a reverse order.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A brake alarm device integrated circuit comprising:
a first primary input end connected to an input end of a first diode; and plurality of first LEDs serially connected, and an input end of the plurality of first LEDs being connected to an output of the first diode;
a second primary input end connected to an input end of a second diode; a first resistor having an input end connected to an input end of the second diode, a first integrated circuit having an input end connected to an output end of the first resistor, and a second integrated circuit having an input end connected to an output end of the first integrated circuit; an output end of the second integrated circuit being connected to an input end of the plurality of first LEDs; an input end of a plurality of serial connected second LEDs connected to an output end of the second diode through a second resistor;
a third primary input end connected to an input end of a third diode; a third integrated circuit connected to an output end of the third diode through a third resistor; a plurality of third LEDs which are serially connected; an input of the series of third LEDs being connected to an output of the second diode through a fourth resistor;
outputs of the second and third LEDs being connected to a ground end; and
an output of the third integrated circuit being connected to a first connection between the output of the first integrated circuit and the input of the second integrated circuit;
a fifth resistor being connected between the first connection and a second connection between an output of the first diode and an input of the first serial connected LEDs;
wherein in operation when a high voltage is inputted into the first primary input, current flow through the first diode and then the fifth resistor will conduct the second integrated circuit; a positive bias will cause the second integrated circuit to light up the plurality of first LEDs;
when a high voltage is inputted into the second primary input end, the first resistor will conduct the first integrated circuit; a positive bias will cause the first integrated circuit to light up the second serial connected LEDs; when the bias of the second integrated circuit reduces to a lower level so that the second integrated circuit is conducted, the first LEDs will extinguish; if the high voltage is not further inputted to the first integrated circuit; then the second integrated circuit will restore automatically to emit yellow light;
when a high voltage is inputted into the third primary input end, current flow through the third diode to light up the third serial connected LEDs and the third resistor will conduct the third integrated circuit; a positive bias of the second integrated circuit will be suppressed to be at low level; thereby, the second integrated circuit will be actuated; then the first LEDs will extinguished; if the high voltage is stopped to input to the third primary input end, the first LEDs will light up.

2. The brake alarm device as claimed in claim 1, wherein the LEDs are installed to a circuit board.

3. The brake alarm device as claimed in claim 1, the first LEDs are yellow light, the second LEDs are red light, and the third LEDs are green light.

4. The brake alarm device as claimed in claim 3, wherein the red light represents a brake control signal.

5. The brake alarm device as claimed in claim 1, wherein the green light represents an oil valve signal.

6. The brake alarm device as claimed in claim 1, wherein the yellow light represents that the brake is not actuated.
